(19) United States
(12) Patent Application Publication
(10) Pub. No.: US 2015/0174856 A1
(43) Pub. Date: Jun. 25, 2015

(54) REINFORCED GLASS-FIBRE MAT

(71) Applicant: DALSAN YATIRIM VE INSAAT A.S., Ankara (TR)

(72) Inventors: Mehmet Bahattin Daloglu, Ankara (TR); Timucin Daloglu, Ankara (TR)

(73) Assignee: DALSAN YATIRIM VE INSAAT A.S., Ankara (TR)

(21) Appl. No.: 14/403,265

(22) PCT Filed: May 24, 2013
(86) PCT No.: PCT/IB2013/054293

§ 371 Date: Nov. 24, 2014

(30) Foreign Application Priority Data
May 24, 2012 (TR) 2012/06081

(51) Int. Cl. B32B 5/26; B32B 5/02

(52) U.S. Cl. CPC B32B 5/26; B32B 5/022; B32B 5/024; B32B 2250/03; B32B 2250/20; B32B 2260/021; B32B 2260/044; B32B 2262/101; B32B 2419/00; B32B 2607/00

(57) ABSTRACT

The present invention relates to a reinforced glass-fibre mat (1) which is usually used in building sector and production of gypsum board.

### TECHNICAL FIELD

The present invention relates to a reinforced glass-fibre mat which is usually used in building sector and production of gypsum board.

### BACKGROUND OF THE INVENTION

In building sector, particularly in production of gypsum board, glass-fibre mat enabling to turn gypsum into board by coating it from both sides thereof is used. Glass-fibre mats comprise a glass-fibre layer and a filling layer which is improving the tensile strength of the said glass-fibre layer and providing resistance to water. The glass-fibre layer is fed from a roller to the area where the filling fluid tank composing the filling layer is located. There is a rotating cylinder inside the tank where the filling fluid generating the filling layer is provided. The said cylinder receives the filling fluid inside the tank by rotating and plasters this fluid to the glass-fibre layer passing over it. Thereafter, the fluid puddled onto the said glass-fibre layer in excess is scraped by a scraper and returned into the filling fluid tank. After the scraping process, the glass-fibre mat comprising the glass-fibre layer and the filling layer is sent to drying and becomes final product.

However, glass-fibre mats which are produced using only filling material cannot present desired strength and cause occuring of various fractures during the usage.

The United States patent document no. US2010/0087114 discloses a glass-fibre mat consisting of glass-fibre layer and fill layer. It is also disclosed in the said patent document that glass-fibre mat has low strength. In the said United States patent document, it is disclosed that modification is done at the angle made by the glass-fibre layer via coating roller during coating in the process of coating by filling fluid.

The United States patent document no. U.S. Pat. No. 6,547,901 discloses a plasterboard. The said plasterboard is obtained by coating the plaster with glass-fibre mats from its edges. In the said United States patent document, it is disclosed that reinforcement element is placed between glass-fibre mat and plaster. However, production of this plasterboard is both difficult and costly.

### SUMMARY OF THE INVENTION

An objective of the present invention is to realize a reinforced glass-fibre mat with increased strength properties.

Another objective of the present invention is to realize a reinforced glass-fibre mat which is resistant to flame.

A further objective of the present invention is to realize a reinforced glass-fibre mat which is resistant to moisture.

### DETAILED DESCRIPTION OF THE INVENTION

“The Reinforced Glass-Fibre Mat” realized to fulfil the objectives of the present invention is shown in the figures attached, in which:

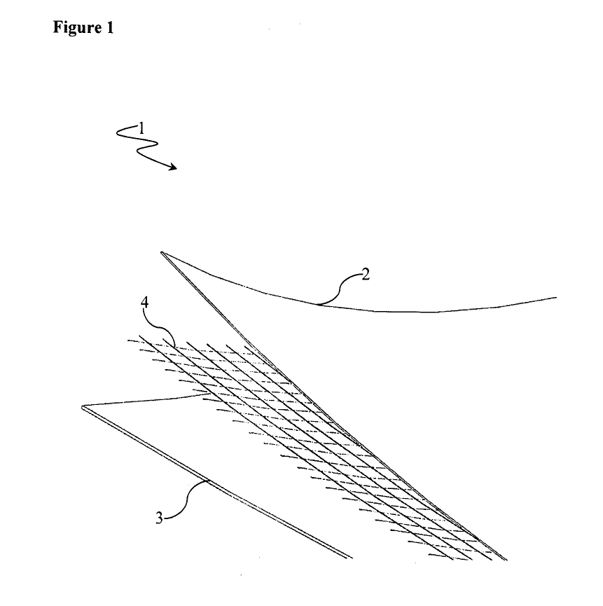

FIG. 1 is an exploded perspective view of the glass-fibre mat.

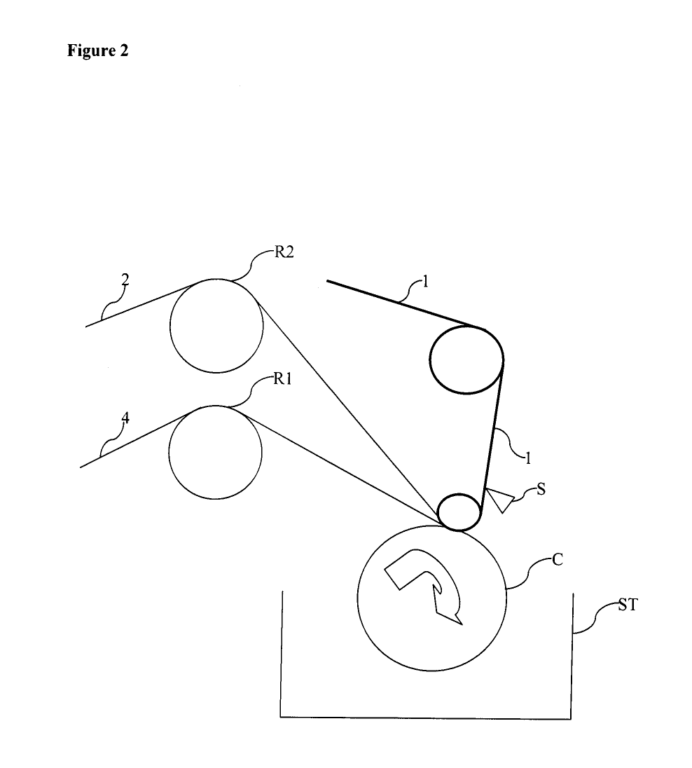

FIG. 2 is a partial view of the production line of the glass-fibre mat.

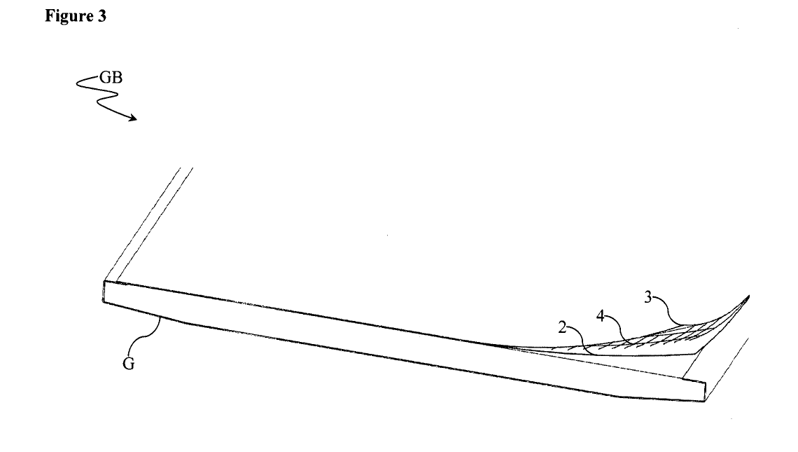

FIG. 3 is a schematic view of the gypsum board produced using the glass-fibre mats.

The components illustrated in the figures are individually numbered, where the numbers refer to the following:

1. Glass-fibre mat

2. Glass-fibre layer

3. Filling layer

4. Reinforcement element

R1. First roller

R2. Second roller

ST. Filling fluid tank

C. Cylinder

S. Scraper

G. Gypsum

GB. Gypsum board

The inventive reinforced glass-fibre mat (1) comprises:
at least one glass-fibre layer (2) which is made of combining glass-fibres;
at least one filling layer (3) which increases strength properties of the glass-fibre layer (2); and
at least one reinforcement element (4) which is located between the glass-fibre layer (2) and the filling layer (3) and provides a massive increase in strength

### (FIG. 1).

The glass-fibre layer (2) is a layer which is obtained by compressing the glass-fibres while aligning them in rows.

The filling layer (3) is obtained by spreading the filling fluid onto the glass-fibre layer (2) in desired thickness and such that it will be distributed on the glass-fibre layer (2) surface equally. The said filling layer (3) increases tensile strength of the glass-fibre layer (2) at a certain degree.

The reinforcement element (4) can be any material that is synthetic, can be woven, strength enhancing, portable and flexible such as polypropylene, glass-fibre, carbon-fibre or very thin steel plate. The said reinforcement element (4) is coated by the filling fluid composing the filling layer (3) together with the glass-fibre layer (2) during production. Thus, it is ensured that the reinforcement element (4) and the glass-fibre layer (2) are integral with one another and do not dissociate from each other.

In production of the inventive glass-fibre mat (1), the glass-fibre layer (2) is fed from a roller (R2) whereas the reinforcement element (4) is fed from another roller (R1). The glass-fibre layer (2) and the reinforcement element (4) contact each other when they come over the cylinder (C) where they will be coated by the filling liquid and they are coated by the filling liquid on the movable cylinder (C) located inside the filling fluid tank (ST). The excessive filling liquid puddled onto the glass-fibre layer (2) and reinforcement element (4) after the coating process is scraped over the glass-fibre layer (2) and the reinforcement element (4) preferably by means of a scraper (S) and it is transmitted back to the filling fluid tank (ST). The produced glass-fibre mat (1) comprising the reinforcement element (4) and the filling layer (3) as a result of coating is then sent to drying from here and becomes final product after drying (FIG. 2).

The inventive glass-fibre mat (1) is used in production of gypsum board (GB) used in building sector, by coating the gypsum (G) from both sides thereof upon taking the gypsum (G) in between preferably. In an embodiment of the invention, it is sufficient that at least one of the glass-fibre mats (1) coating the gypsum (G) comprises the reinforcement element (4). However, in a preferred embodiment of the invention the glass-fibre mat (1) located in both sides of the gypsum comprises the reinforcement element (4) for preventing confusion of which side comprises the reinforcement element (4) while using the gypsum board (GB) (FIG. 3).

It is possible to develop various embodiments of the inventive reinforced glass-fibre mat (1), it cannot be limited to examples disclosed herein and it is essentially according to claims.

1. A glass-fibre mat (1) comprising:
at least one glass-fibre layer (2) which is made of combining glass-fibres;
at least one filling layer (3) which increases strength properties of the glass-fibre layer (2);
at least one reinforcement element (4) which is located Between the glass-fibre layer (2) and the filling layer (3) and provides a massive increase in strength; and characterized by coating the gypsum (G) from both sides upon Taking the gypsum (G) in between and being used in production of gypsum board (GB) Used in building sector.

2. A glass-fibre mat (1) according to claim 1, characterized by the reinforcement element (4) which is any material that is synthetic, can be woven, strength enhancing, portable and flexible such as polypropylene, glass-fibre, carbon-fibre.

3. (canceled)

4. (canceled)
